(19) United States
(12) Patent Application Publication
(10) Pub. No.: US 2009/0141842 A1
(43) Pub. Date: Jun. 4, 2009

(54) Clock signal transmission method in radio communication apparatus, and radio communication apparatus

(75) Inventor: Tomoyuki Nakao, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/285,131

(22) Filed: Sep. 29, 2008

(30) Foreign Application Priority Data
Dec. 4, 2007 (JP) 2007-313564

(51) Int. Cl. H04L 7/00

(52) U.S. Cl. 375/354

(57) ABSTRACT

A radio communication apparatus includes a transmission clock signal generation part, when a harmonic component of a first clock signal used by a clock signal using part agrees with a reception frequency of the radio communication apparatus, generating a second clock signal different from the first clock signal; a clock signal transmission part transmitting the second clock signal, generated by the transmission clock signal generation part, for the clock signal using part, and a use clock signal generation part generating the first clock signal from the second clock signal, transmitted by the clock signal transmission part, and provide the generated first clock signal to the clock signal using part.

### CROSS-REFERENCE TO RELATED APPLICATIONS

This application is based upon and claims the benefit of priority of the prior Japanese Patent Application No. 2007-313564, filed on Dec. 4, 2007, the entire contents of which are incorporated herein by reference.

### FIELD

The embodiments discussed herein are directed to a clock signal transmission method in a radio communication apparatus, and a radio communication apparatus.

### BACKGROUND

In a radio communication apparatus, in particular, a portable device such as a cellular phone, there is a case where, for the purpose of miniaturization of a size, a reception antenna for receiving a radio signal and an internal circuit are disposed in close proximity. In such a case, a harmonic noise of a clock signal which is an internal signal may be received by the reception antenna, and thereby, reception interference may occur.

In a digital electronic device such as the above-mentioned cellular phone, operation timing of each internal circuit part is in synchronization with a clock signal. In such a configuration, the clock signal is provided to each internal circuit part, and thus, a clock signal transmission wiring member is provided for a long distance. Thereby, an influence of a harmonic noise radiated from the clock signal transmission wiring member may become a serious problem.

Especially, in a cellular phone in a folding type or a clamshell type having a fixed part and a movable part, a clock signal is transmitted by a cable or a wiring pattern which passes through a hinge part. In such a case, a harmonic component of the clock signal radiated from the cable or wiring pattern may cause reception interference.

FIG. 1 depicts an internal perspective view of such a folding type cellular phone as one example of a radio communication apparatus, and in particular, depicts an example of a configuration of a part concerning transmission of a clock signal.

The cellular phone 500′ of FIG. 1 includes a fixed part 500B′ and a movable part 500A′. The movable part 500A′ and the fixed part 500B′ are connected via a hinge part 400 in such a manner that the movable part 500A′ can be opened from the fixed part 500b′ and then, the movable part 500A′ can be closed to the fixed part 500B′, via the hinge part 400.

In the fixed part 500B′ and the moveable part 500A′, a fixed part substrate 100′ and a movable part substrate 200′, both are circuit substrates, are provided, respectively.

In the fixed part 500B′, a battery 130 for supplying power to drive the cellular phone, and a charging terminal 140 for charging the battery 130 externally, are provided. Also, in the fixed part 500B′, a reception antenna 120 is provided for receiving a radio signal.

Further, on the fixed part substrate 100′, a sending part 110′ configured to transmit a clock signal is provided. On the movable part substrate 200′, a reception part 210′ configured to receive the clock signal is provided. Between the sending part 110′ and the reception part 210′, a cable or a wiring pattern 300 used as a clock signal transmission wiring member is provided.

In the cellular phone 500′ of FIG. 1, the sending part 110′ provided on the fixed part substrate 100′ of the fixed part 500B′ transmits the clock signal to the reception part 210′ provided on the movable part substrate 200′ of the movable part 500A′, via the cable or wiring pattern 300. In this configuration, the cable or wiring pattern 300 is provided to pass through the hinge part 400. Therefore, the cable or wiring pattern 300 passes on or in the vicinity of the reception antenna 120 provided in the vicinity of the hinge 400. Therefore, electromagnetic waves radiated from the clock signal flowing through the cable or wiring pattern 300 may be received by the reception antenna 120, whereby reception interference may occur.

FIG. 2 is a perspective view of one example of a camera provided in the cellular phone 500′, which camera is one example of the above-mentioned sending part 110′.

In the case where the sending part 110′ is the camera as mentioned above, image information of an image taken by the camera is transmitted from the camera in synchronization with a clock signal of 13 MHz for example. The image information is thus transmitted to the reception part 210′ together with the clock signal. The reception part 210′ receives the image information and carries out information processing on the image information. Thus, from the image information, the above-mentioned image taken by the camera is displayed on a screen (not depicted) of the cellular phone 500′, or, the image information is stored in a memory (not depicted) of the cellular phone 500′.

FIG. 3 is a block diagram of a part of an internal configuration of the above-mentioned cellular phone 500′ and illustrates a problem in the related art.

In FIG. 3, (a), a radio signal received by the reception antenna 120 (i.e., a radio antenna) undergoes image processing concerning reception of the radio signal in a radio reception circuit 150 (not depicted in FIG. 1).

Further, the clock signal (FIG. 3, (b) depicts a waveform) is transmitted from the clock generation circuit 110′ acting as the sending part 110′. The clock signal is then transmitted via the cable or wiring part 300, and then, is received by a 13 MHz operation circuit 210′ acting as the reception part 210′.

In the example of FIG. 3, a reception frequency band of the cellular phone 500′ corresponds to a range between 875 and 885 MHz. 884 MHz, which corresponds to the 68-th harmonic component of the 13 MHz clock signal falls within the reception frequency band. Thereby, electromagnetic waves of 884 MHz act as electromagnetic waves of an interference frequency, and thus, may cause reception interference.

In the cellular phone 500′, when the harmonic component of the clock signal thus falls within the reception frequency band, communication error may occur. That is, when electromagnetic waves which the cellular phone 500′ receives has a minimum level to carry out proper radio communication, for example, −90 dBm in reception sensitivity at an antenna terminal, and also, when intensity of the above-mentioned harmonic component of the clock signal exceeds −90 dBm, the reception signal and noise of the harmonic component cannot be distinguished therebetween. Thus, communication error may occur.

In order to solve the problem, a countermeasure part may be inserted in a clock signal generation circuit, and thereby, a harmonic component falling within a reception frequency band is attenuated. However, in this method, a waveform of a clock signal may degrade or may become blunt.

Japanese Laid-Open Patent Application No. 2002-314517 discloses the related art.

### SUMMARY

In the embodiments, when a harmonic component of a first clock signal used by a clock signal using part of a radio communication apparatus agrees with a reception frequency of the radio communication apparatus, a second clock signal different from the first clock signal is generated. The generated second clock signal is then transmitted for the clock signal using part. Then, the first clock signal is generated from the transmitted second clock signal, and is provided to the clock signal using part.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a perspective view of one example of a cellular phone in the related art;

FIGS. 2 and 3 illustrate a problem in the related art;

FIG. 4 is a perspective view of a cellular phone in one embodiment;

FIG. 5 is a perspective view of a camera as one example of a sending part depicted in FIG. 4;

FIG. 6 is a block diagram illustrating a configuration of an embodiment 1;

FIG. 7 is an operation flow chart for obtaining a frequency of a clock signal to be transmitted, in the embodiment 1;

FIG. 8 is a block diagram illustrating a configuration of an embodiment 2;

FIG. 9 illustrates an advantage of the embodiment 2 depicted in FIG. 8;

FIG. 10 is a block diagram illustrating a configuration of an embodiment 3; and

FIGS. 11, 12 and 13 illustrate a method of obtaining a waveform of a clock signal to be transmitted, in the embodiment 3 depicted in FIG. 10.

### DESCRIPTION OF REFERENCE NUMERALS

110, 110-2 clock oscillation circuit (i.e., sending part, or transmission clock signal generation part)

110-1 timing generation circuit (i.e., sending part, or transmission clock signal generation part)

120 reception antenna

150 radio reception circuit

210A frequency conversion circuit (i.e., reception part, or use clock signal generation part)

210A-1 use clock signal generation circuit (i.e., reception part, or use clock signal generation part)

210A-2 waveform shaping circuit (i.e., reception part, or use clock signal generation part)

210B, 210B-1, 210B-2 13 MHz operation circuit (i.e., reception part, terminal part or clock signal using part)

300 cable or wiring pattern (i.e., transmission part or clock signal transmission wiring member)

500 cellular phone (i.e., radio communication apparatus)

### DESCRIPTION OF EMBODIMENTS

The embodiments have been devised in consideration of the above-mentioned problem. An object of the embodiments is to provide a configuration in a radio communication apparatus, in which, when a harmonic component of a clock signal falls within a reception frequency, possible reception interference can be effectively avoided.

In the embodiments, in a radio communication apparatus, when a harmonic component of a first clock signal used by a clock signal using part of the radio communication apparatus agrees with a reception frequency of the radio communication apparatus, a second clock signal different from the first clock signal is generated. Then, the generated second clock signal is transmitted for the clock signal using part. Then, the first clock signal is generated from the transmitted second clock signal, and is provided to the clock signal using part.

In this configuration of the embodiments, when a harmonic component of a first clock signal used by a clock signal using part of the radio communication apparatus agrees with a reception frequency of the radio communication apparatus, a second clock signal different from the first clock signal is generated. Then, the generated second clock signal is transmitted for the clock signal using part. The second clock signal generated as mentioned above is such that an influence on the reception frequency is sufficiently reduced. As a result, when the second clock signal is transmitted via an above-mentioned cable or wiring terminal which passes on or in the vicinity of an antenna, reception interference can be effectively avoided. This is because the second clock signal is such that an influence on the reception frequency is sufficiently reduced is mentioned above.

Then, after the second clock signal such that an influence on the reception frequency is sufficiently reduced as mentioned above is thus transmitted to the clock signal using part, the first clock signal is generated from the transmitted second clock signal, and then, is provided to the clock signal using part. As a result, the clock signal using part can positively obtain the first clock signal.

Thus, in the embodiments, in a radio communication apparatus using a clock signal, it is possible to effectively avoid reception interference otherwise occurring because of transmission of the clock signal.

That is, in the embodiments, when a clock signal which is an internal signal of a radio communication apparatus is transmitted, a case is assumed. In the case, a certain part in the radio communication apparatus receives and uses the clock signal. The clock signal, referred to as a use clock signal or a first clock signal, has a harmonic component which falls within a reception frequency band of the radio communication apparatus. In this case, another clock signal, referred to as a transmission clock signal or a second clock signal, different from the use clock signal, is generated. The transmission clock signal does not include any harmonic component which may cause problematic reception interference. The transmission clock signal is then transmitted for the above-mentioned certain part which uses the use clock signal. Then, in the vicinity of the certain part, referred to as a terminal part or a clock signal using part, the use clock signal is generated from the thus-transmitted transmission clock signal. The thus-generated use clock signal is then provided to the certain part.

In this case, a second frequency of the transmission clock signal may be determined as an integer multiple of a first frequency of the use clock signal. Then, after the transmission clock signal is transmitted in the vicinity of a terminal part as the clock signal using part, a frequency conversion circuit converts the second frequency of the transmission clock signal to be 1/the integer multiple, and thus, generates the use clock signal having the first frequency. This configuration will be described later in detail as the embodiment 1.

Alternatively, as the transmission clock signal, a periodic timing signal of a frequency which is 1/integer of a first frequency of the use clock signal is generated. Then, after the transmission clock signal is transmitted in the vicinity of a terminal part as the clock signal using part, a use clock oscillation circuit generates the use clock signal in synchronization with the periodic timing signal having been transmitted thereto. This configuration will be described later in detail as the embodiment 2.

Further alternatively, Fourier transform is carried out on a waveform of the use clock signal to obtain a spectrum of the use clock signal. Thus, harmonic components of the use clock signal are digitized. Then, harmonic components which may cause reception interference are removed from the spectrum, and thus, a new spectrum is obtained. Then, inverse Fourier transform is carried out on the thus-obtained new spectrum from which the harmonic components which may cause reception interference have been thus removed. Thus, a corresponding waveform on a time axis is calculated. The transmission clock signal having the thus-calculated waveform on a time axis is generated, and is transmitted to a terminal part as the clock signal using part. This configuration will be described later in detail as the embodiment 3.

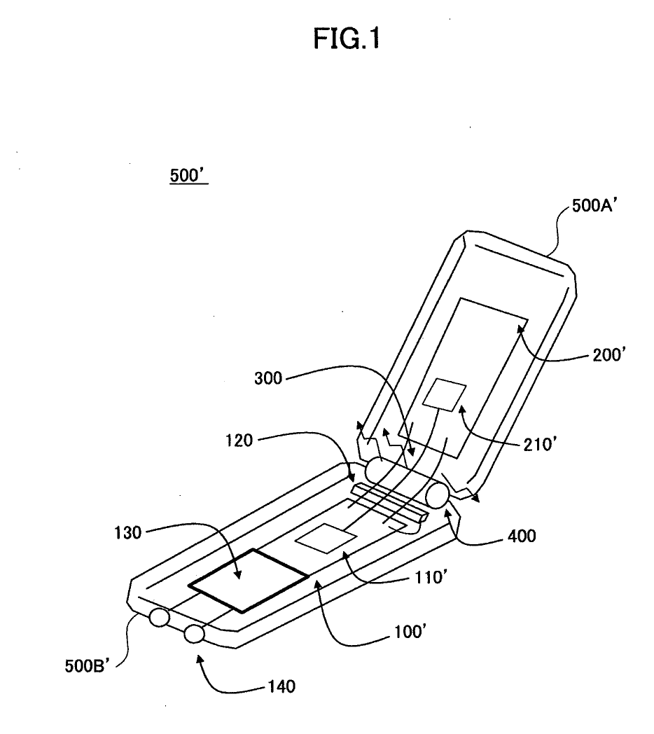

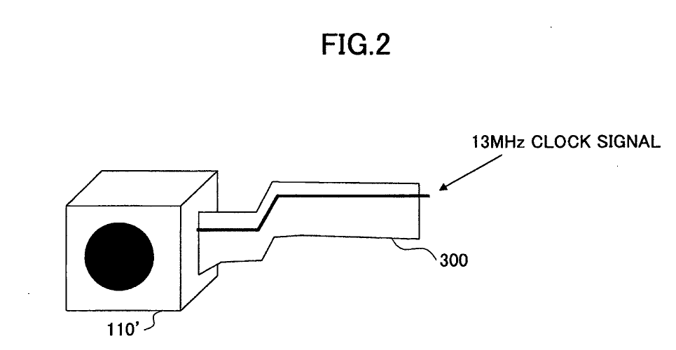

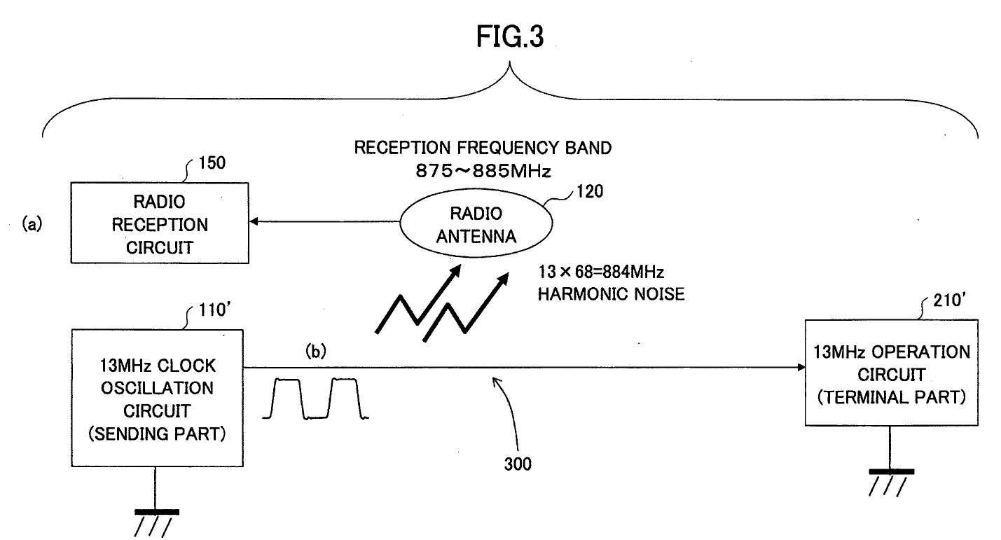

Thus, in the embodiments, a transmission clock signal which is transmitted via a transmission part as a clock signal transmission wiring member (i.e., a cable or wiring pattern (or a flexible cable) 300 depicted in FIG. 1) is a signal which does not include any harmonics which may cause problematic reception interference or a signal in which harmonics which may cause problematic reception interference are sufficiently reduced. The transmission clock signal is then transmitted via the transmission part, to the terminal part as the clock signal using part. Then, the use clock signal is generated based on the thus-transmitted transmission clock signal, and the use clock signal is then provided to the terminal part.

In this method, it is possible to effectively suppress problematic harmonic noise, which may be a main cause of reception interference, radiated from the transmission part acting as the clock signal transmission wiring member. Therefore, it is possible to effectively avoid reception interference.

The embodiments will now be described in detail with reference to figures.

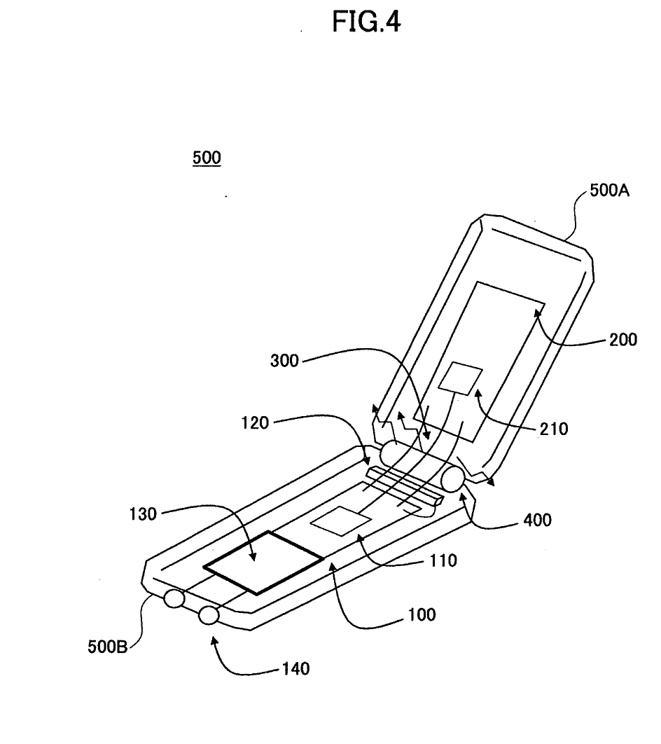

A radio communication apparatus in each of the embodiments 1 through 3 has a configuration of a folding type cellular phone 500 as depicted in FIG. 4. The folding type cellular phone 500 has a configuration similar to a configuration of the cellular phone 500′ described above as the related art with reference to FIG. 1. In the cellular phone 500 in each of the embodiments 1 through 3, instead of the sending part 110′ and the reception part 210′ in the cellular phone 500′ of the related art, a sending part 110 and a reception part 210 having respective different configurations are provided, respectively.

A cellular phone 500 of FIG. 4 includes a fixed part 500B and a movable part 500A. The movable part 500A and the fixed part 500B are connected together via a hinge part 400 in such a manner that the movable part 500A can be opened from the fixed part 500B and then, the movable part 500A can be closed to the fixed part 500B, via the hinge part 400.

In the fixed part 500B and the moveable part 500A, a fixed part substrate 100 and a movable part substrate 200, both are circuit substrates, are provided, respectively.

In the fixed part 500B, a battery 130 for supplying power to drive the cellular phone, and a charging terminal 140 for charging the battery 130 externally, are provided. Further, in the fixed part 500B, a reception antenna 120 is provided for receiving a radio signal.

Further, on the fixed part substrate 100, a sending part 110 configured to transmit a transmission clock signal is provided. On the movable part substrate 200, a reception part 210 configured to receive the transmission clock signal is provided. Between the sending part 110 and the reception part 210, a cable or wiring pattern 300 used as a clock signal transmission wiring member is provided.

In the cellular phone 500 of FIG. 4, the sending part 110 provided on the fixed part substrate 100 of the fixed part 500B transmits the transmission clock signal to the reception part 210 provided on the movable part substrate 200 of the movable part 500A, via the cable or wiring pattern 300. In this configuration, the cable or wiring pattern 300 is provided to pass through the hinge part 400. Therefore, the cable or wiring pattern 300 passes on or in the vicinity of the reception antenna 120 provided in the vicinity of the hinge 400.

In each of the embodiments 1 through 3, as mentioned above, the transmission clock signal is a signal in which an influence to the reception frequency band is sufficiently reduced. Therefore, problematic harmonic components are hardly radiated from the transmission clock signal which is transmitted via the cable or wiring pattern 300. Therefore, reception interference can be effectively suppressed.

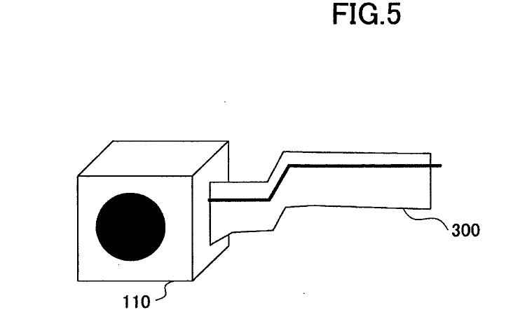

FIG. 5 is a perspective view of one example of a camera provided in the cellular phone 500, which camera is one example of the sending part 110.

In the case where the sending part 110 is the camera as mentioned above, image information of an image taken by the camera is transmitted from the camera in synchronization with the transmission clock signal. The image information is thus transmitted to the reception part 210 together with the transmission clock signal. The reception part 210 receives the image information and carries out information processing on the image information. Thus, from the image information, the above-mentioned image taken by the camera is displayed on a screen (not depicted) of the cellular phone 500, or, the image information is stored in a memory (not depicted) of the cellular phone.

The embodiment 1 will now be described.

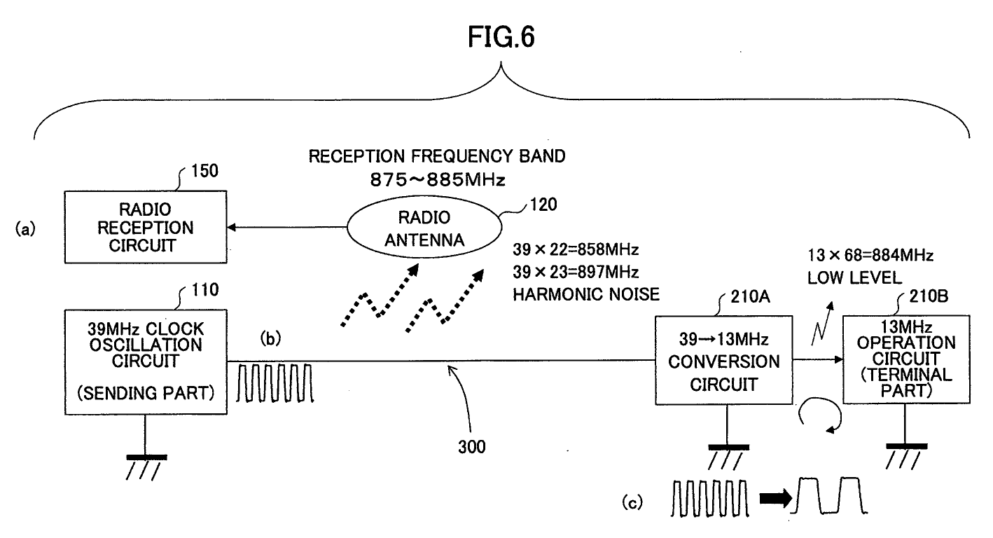

FIG. 6 is a block diagram illustrating a configuration of the embodiment 1.

In a cellular phone in the embodiment 1, a clock signal oscillation circuit acting as the sending part 110 is provided to generate the transmission clock signal which does not include any harmonic components falling within a reception frequency band. Further, in the cellular phone in the embodiment 1, the cable or wiring pattern 300 as the transmission part 300 for transmitting the transmission clock signal is included. Further, in the cellular phone in the embodiment 1, a frequency conversion circuit 210A (which is included in the reception part 210 in the configuration depicted in FIG. 4), for generating the use clock signal used by the clock signal using part, from the transmission clock signal.

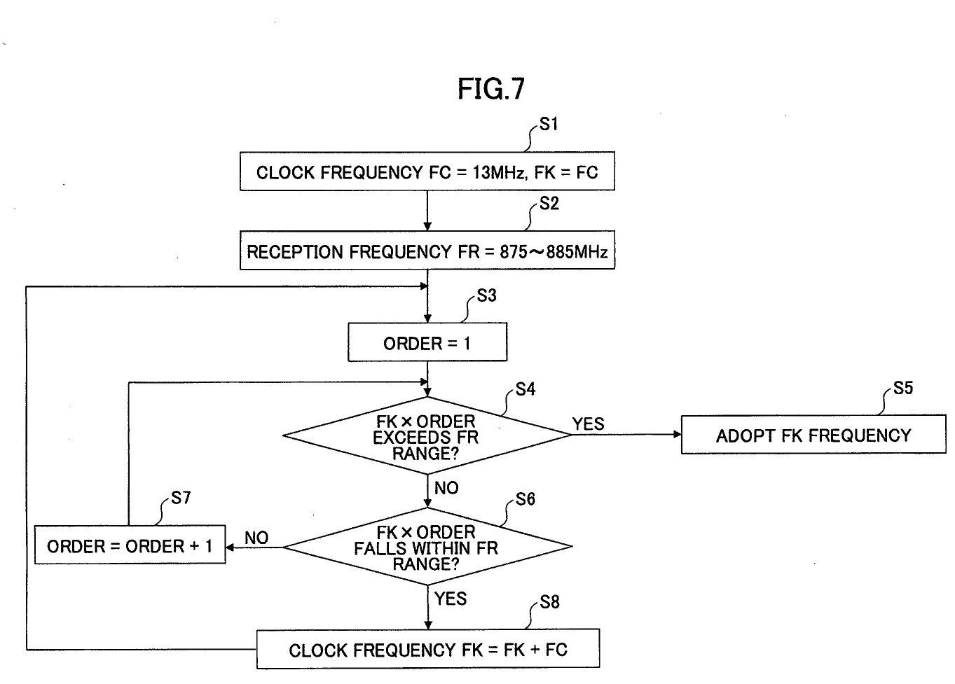

The transmission clock signal generated by the sending part 110 in the embodiment 1 is a signal which does not include any harmonic components falling within the reception frequency band. Specifically, assuming that the use clock signal is 13 MHz in the cellular phone and the reception frequency is 875 through 885 MHz, if the use clock signal as it is were transmitted via the cable or wiring pattern 300, a problematic harmonic component of 884 MHz (=13×68=884, i.e., 68-th harmonic component of the use clock signal of 13 MHz) would be radiated from the use clock signal thus transmitted via the cable or wiring pattern 300, which thus may cause reception interference Therefore, in the embodiment 1, in the sending part 110 (i.e., the clock oscillation circuit), the transmission clock signal of a frequency of an integer multiple of 13 MHz, the frequency of the use clock signal, specifically, 39 MHz, which is a multiple of 13 MHz (i.e., 13×3 39), for example, is generated. The specific order of the multiple is determined such that harmonic components of the resulting frequency do not fall within the reception frequency band. A specific method to determine the specific order of the multiple will be described later with reference to FIG. 7.

When the thus-generated transmission clock signal is transmitted via the cable or wiring pattern 300, no harmonic noise which may cause reception interference is radiated, and thus, no reception interference occurs. That is, the 22-nd harmonic of 39 MHz of the transmission clock signal is 858 MHz (<875 MHz), and also, the next 33-rd harmonic of 39 MHz of the transmission clock signal is 897 MHz (>885 MHz). Therefore, there are no harmonic components of 39 MHz of the transmission clock signal which fall within the reception frequency band 875 through 885 MHz. Therefore, no reception interference otherwise cased by problematic harmonic components occurs.

The frequency conversion circuit 210A is provided in the vicinity of a 13 MHz operation circuit 210B (which is included in the reception part 210 together with the frequency conversion circuit 210A), which acts as the terminal part which acts as the clock signal using part.

In the frequency conversion circuit 210A, the transmission clock signal having been transmitted via the cable or wiring pattern 300 is processed. Specifically, the frequency conversion circuit 210A carries out frequency conversion to divide the frequency of the given signal by 3. As a result of 39 MHz of the given transmission clock signal being thus divided by 3, the frequency conversion circuit 210A generates the use clock signal of 13 MHz to be used by the 13 MHz operation circuit 210B. For the purpose of thus dividing the given frequency by 3, a well-known method using a ternary counter or such may be used in the frequency conversion circuit 210A.

It is noted that, from the frequency conversion circuit 210A which generates the use clock signal of 13 MHz, the above-mentioned 884 MHz (=13×68) of the problematic harmonic component which may cause reception interference is radiated. However, as mentioned above, the frequency conversion circuit 210A is provided in the vicinity of the 13 MHz operation circuit 210B which actually uses the use clock signal. Therefore, the length of the transmission path for transmitting the use clock signal of 13 MHz itself is so short that the above-mentioned radiation of the problematic harmonic component from the transmission path can be reduced sufficiently.

That is, as mentioned above, a separation between the frequency conversion circuit 210A which generates the use clock signal and the 13 MHz operation circuit 210B which uses the use clock signal is sufficiently short. Thereby, a current path generated by the transmission path transmitting the 13 MHz use clock signal is a very small loop. Thereby, a radiation level of electromagnetic waves of the above-mentioned problematic harmonic component of 13 MHz of the use clock signal is sufficiently low. Thus, it is possible to sufficiently suppress reception interference.

With reference to FIG. 7, a specific method of determining a frequency of the transmission clock signal in the embodiment 1 will now be described.

In FIG. 7, in step S1, a frequency of the use clock signal is set in a variable, FC. In the above-mentioned example, FC=13 [MHz]. Then, FC is set as an initial value of a variable, FK for a candidate of a frequency of the transmission clock signal.

In step S2, a reception frequency band FR is set. In the above-mentioned example, FR=875 through 885 [MHz].

In step S3, as an order of a multiple for FK, 1 is set as an initial value.

In step S4, FK is multiplied by the above-mentioned order, i.e., FK×order. Then, it is determined whether the thus-obtained value (FK×order) exceeds FR. When the thus-obtained value (FK×order) exceeds FR (YES), a current value of FK is finally determined as a frequency of the transmission clock signal (step S5).

On the other hand, when the thus-obtained value (FK×order) does not exceed FR (NO in step S4), step S6 is carried out.

In step S6, it is determined whether FK×order falls within FR. When FK×order does not fall within FR (NO), step S7 is carried out. In step S7, the order is incremented by 1, and then, step S4 is returned to.

When FK×order falls within FR (YES in step S6), addition operation of FK+FC is carried out, and FK is updated by the addition operation result (step S8). Then, step S3 is returned to.

After that, the operation of steps S3, S4, S6, S7 and S8 is repeated until the determination result of step S4 becomes YES.

In the above-mentioned example, that is, when the use clock signal has the frequency FC=13 [MHz], and the reception frequency band FR=875 through 885 [MHz], the operation of FIG. 7 described above will be carried out as follows:

In this case, in a loop operation of steps S4, S6 and S7, up to the order becomes 67, FK×order=13×67=871 [MHz], which does not fall within FR=875 through 885 [MHz]. Therefore, each of determination results of steps S4 and S6 is NO. Thus, the loop operation is repeated.

Then, when the order becomes 68, FK×order=13×68=884 [MHz], which has not exceeded the reception frequency band FR=875 through 885 [MHz]. Therefore, a determination result of step S4 is NO. Thus, step S6 is carried out. In step S6, the above-mentioned value FK×order=884 [MHz] falls within the reception frequency band FR=875 through 885 [MHz]. Therefore, a determination result of step S6 becomes YES. As a result, step S8 is carried out. In step S8, FK is updated as follows: FK=FK+FC=13+13=26 [MHz].

Then, in the state of FK=26 [MHz], in the above-mentioned loop operation of steps S4, S6 and S7, up to the order becoming 33, FK×order=26×33=858 [MHz], which does not fall within FR=875 through 885 [MHz]. Therefore, each of determination results of steps S4 and S6 is NO. Thus, the loop operation is repeated.

Then, when the order becomes 34, FK×order=26×34=884 [MHz], which has not exceeded the reception frequency band FR=875 through 885 [MHz]. Therefore, a determination result of step S4 is NO. Thus, step S6 is carried out. In step S6, the above-mentioned value FK×order=884 [MHz] falls within the reception frequency band FR=875 through 885 [MHz]. Therefore, a determination result of step S6 becomes YES. As a result, step S8 is carried out. In step S8, FK is updated as follows: FK=FK+FC=26+13=39 [MHz].

Then, in the state of FK=39 [MHz], in the above-mentioned loop operation of steps S4, S6 and S7, up to the order becoming 22, FK×order=39×22=858 [MHz], which does not fall within FR=875 through 885 [MHz]. Therefore, each of determination results of steps S4 and S6 is NO. Thus, the loop operation is repeated.

Then, when the order becomes 23, FK×order=39×23=897 [MHz], which has exceeded the reception frequency band FR=875 through 885 [MHz]. Therefore, a determination result of step S4 is YES. In this case, step S5 is carried out, and the above-mentioned value FK=39 [MHz] is adopted finally as a frequency of the transmission clock signal.

Thus, as a multiple of the frequency of the use clock signal FC is updated in sequence in step S8, an increasing amount of the harmonic component (i.e., FK×order) in step S4, which is a multiple of FK, increases accordingly. As a result, the increasing amount then becomes such that the increasing amount straddles the reception frequency band. Thus, the corresponding harmonic components do not fall within the reception frequency band. The value of FK occurring at this time is adopted finally as a frequency of the transmission clock signal.

In the above-mentioned example, when FK is 13 or 26 [MHz], an increasing amount of the harmonic component which is the multiple of FK has not yet become such that the increasing amount straddles the reception frequency band. Therefore, the harmonic component falls within the reception frequency band accordingly. When FK is 39 [MHz], and when the order is 22, FK×order=39×22=858 [MHz]<875 [MHz] which is a lower limit of the reception frequency band. Then, in the next order of 23, FK X order=39×23=897 [MHz]<885 [MHz] which is an upper limit of the reception frequency band. Thus, the increasing amount straddles the reception frequency band. Thus, both harmonic components do not fall within the reception frequency band. Therefore, 39 [MHz] is adopted finally as a frequency of the transmission clock signal.

Next, the embodiment 2 will be described.

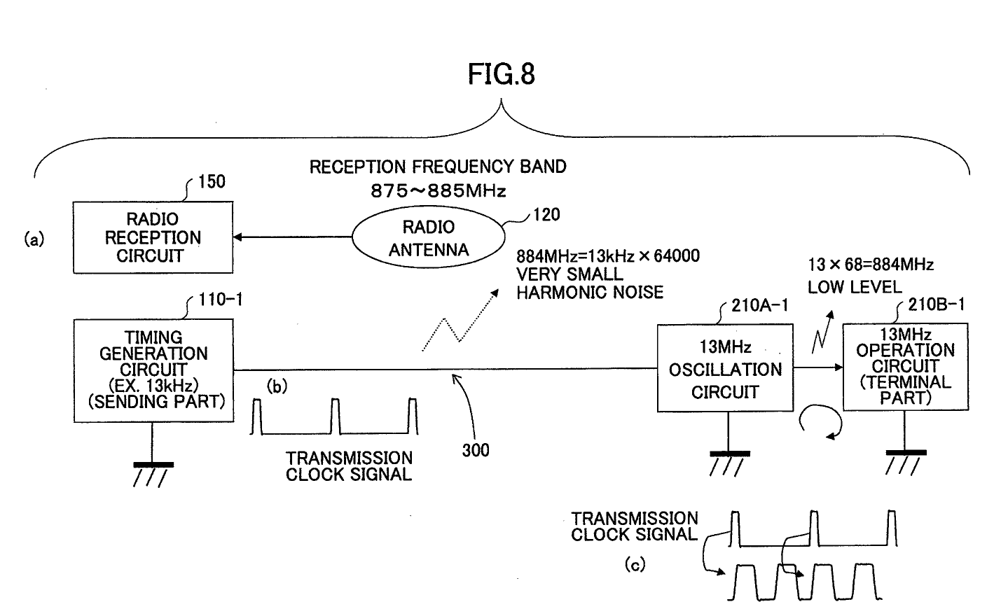

In a configuration of the embodiment 2 which is depicted in FIG. 8, (a), a timing generation circuit 110-1 (corresponding to the sending part 110 in the configuration depicted in FIG. 4) generates a timing signal. The timing signal is used as the transmission clock signal, as shown in FIG. 8, (b), having a frequency of 1/integer of 13 MHz which is a frequency of the use clock signal. The thus-generated timing signal is transmitted via the cable or wiring pattern 300 used as the transmission part. Then, in an oscillation circuit 210A-1 (included in the reception part 210), provided in the vicinity of the 13 MHz operation circuit 210B-1 (also included in the reception part 210), the use clock signal of 13 MHz is generated in synchronization with the timing signal thus transmitted via the cable or wiring pattern 300. The thus-generated use clock signal is then provided to the 13 MHz operation circuit 210B-1.

Specifically, in the timing generation circuit 110-1, the timing signal of 13 KHz, which is 1/1000 of 13 MHz of the use clock signal is generated. The timing signal has a waveform as depicted in FIG. 8, (b), for example.

It is noted that, from the 13 kHz timing signal, which is transmitted via the cable or wiring pattern 300 used as the transmission part, a plurality of harmonic components are radiated which fall within the reception frequency band. However, because the original frequency of the harmonic components is as low as 13 kHz as mentioned above, orders of harmonic components falling within the reception frequency band 875 through 885 MHz should be approximately 64000. Because the orders of the problematic harmonic components are thus very high, levels of the harmonic components are so low that the harmonic components cannot act as problematic noise. Therefore, reception interference, which may occur when the timing signal used as the transmission clock signal is transmitted via the cable or wiring pattern 300 from the timing generation circuit 110-1 to the 13 MHz operation circuit 210B-1 acting as the clock signal using circuit, can be effectively controlled.

Then, in the oscillation circuit 210A-1 which is provided in the vicinity of the 13 MHz operation circuit 210B-1, as shown in FIG. 8, (c), the use clock signal of 13 MHz, having the correct timing, can be generated as being in synchronization with the timing signal of 13 kHz, which has been thus transmitted via the cable or wiring pattern 300. It is noted that, FIG. 8, (c) diagrammatically depicts a method of generating pulses in synchronization with each timing pulse of such a timing signal (depicted in an upper part of FIG. 8, (c)) having a relatively low frequency corresponding to the 13 kHz timing signal. Thereby, a use clock signal (depicted in a lower part of FIG. 8, (c)) having a higher frequency corresponding to the 13 MHz clock signal is generated. In such a way, the oscillation circuit 210A-1 generates the use clock signal of 13 MHz from the given timing signal of 13 kHz.

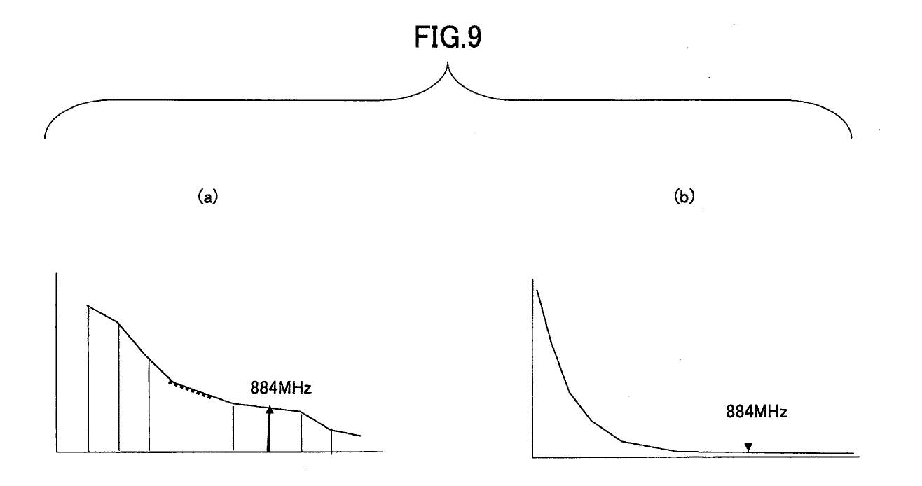

FIG. 9, (a) depicts an example of a level of noise of a harmonic component of 884 MHz occurring when the use clock signal of 13 MHz were transmitted as it is. In contrast thereto, FIG. 9, (b) depicts an example of a level of noise of a harmonic component of 884 MHz falling within the reception frequency band 875 through 885 MHz when the timing signal of 13 kHz which is 1/1000 of a frequency 13 MHz of the use clock signal is transmitted, instead, as in the embodiment 2. The example depicted in FIG. 9, (b) is an example in which a duty ratio of the timing signal is 10%.

As can be seen from FIG. 9, (b), in comparison to FIG. 9, (a), when the timing signal of 13 kHz is transmitted, the noise level of the harmonic component of 884 MHz falling within the reception frequency band 875 through 885 MHz is so reduced that the corresponding noise level can be ignored.

It is noted that a duty ratio of the timing signal of 13 kHz is preferably 50% (i.e., a time interval in which a signal level is high is equal to a time interval in which a signal level is low, in a pulse signal. Generally speaking, when a duty ratio is 50%, a harmonic component is most hardly generated.

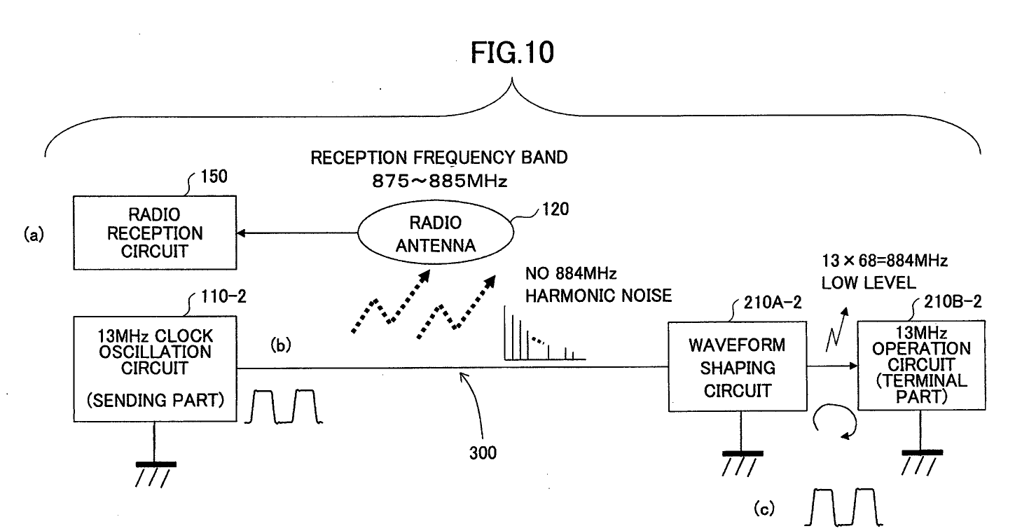

With reference to FIGS. 10 through 13, the embodiment 3 will be described now.

In the embodiment 3, as shown in FIG. 10, a signal of a waveform including a spectrum, from which a harmonic component (in the above-mentioned example, a harmonic component of 884 MHz) falling within the reception frequency band 875 through 885 MHz which may cause reception interference is removed, is generated in a clock oscillation circuit 110-2 (corresponding to the sending part 110 of FIG. 4), which acts as the sending part for sending the transmission clock signal.

Thus, in the embodiment 3, the transmission clock signal from which the harmonic component falling within the reception frequency band 875 through 885 MHz has been thus removed in spectrum is then transmitted via the cable or wring pattern 300 used as the transmission part. Thus, reception interference concerning transmission of the transmission clock signal in the radio communication apparatus can be effectively suppressed.

The method of the embodiment 3 is advantageous in comparison to the related art in which a filter made of a bypass capacitor or such is used as a countermeasure part provided for the purpose of controlling reception interference. This is because a signal waveform of the transmission clock signal can be prevented from becoming blunt because only a specific frequency component in the transmission clock signal is made to be zero in the embodiment 3, as will be described now with reference to figures.

As shown in FIG. 10, the radio communication apparatus in the embodiment 3 includes the clock oscillation circuit 110-2 as the sending part generating the transmission clock signal. The radio communication apparatus further includes the cable or wiring pattern 300 used as the transmission part, and a waveform shaping circuit 210A-2 (included in the reception circuit 210) used for obtaining the use clock signal from the transmission clock signal having been transmitted via the cable or wiring pattern 300. The radio communication apparatus further includes a 13 MHz operation circuit 210B-2 (included in the reception circuit 210) which is the clock signal using part and is the terminal part.

The clock oscillation circuit 110-2 generates the transmission clock signal from which the harmonic component of 884 MHz falling within the reception frequency band of 875 through 885 MHz is removed in a spectrum, from the given use clock signal of 13 MHz. The thus-obtained transmission clock signal is then transmitted via the cable or wiring pattern 300, and after that, the waveform shaping circuit 210A-2 provided in the vicinity of the 13 MHz operation circuit 210B-2 receives the transmission clock signal. The waveform shaping circuit 210A-2 then shapes the waveform of the received transmission clock signal, so that, in the resulting signal, the harmonic component of 884 MHz, having been removed in the clock oscillation circuit 110-2 as mentioned above, is restored. Thus, the use clock signal of 13 MHz is generated. The thus-obtained use clock signal of 13 MHz is then provided to the 13 MHz operation circuit 210B-2.

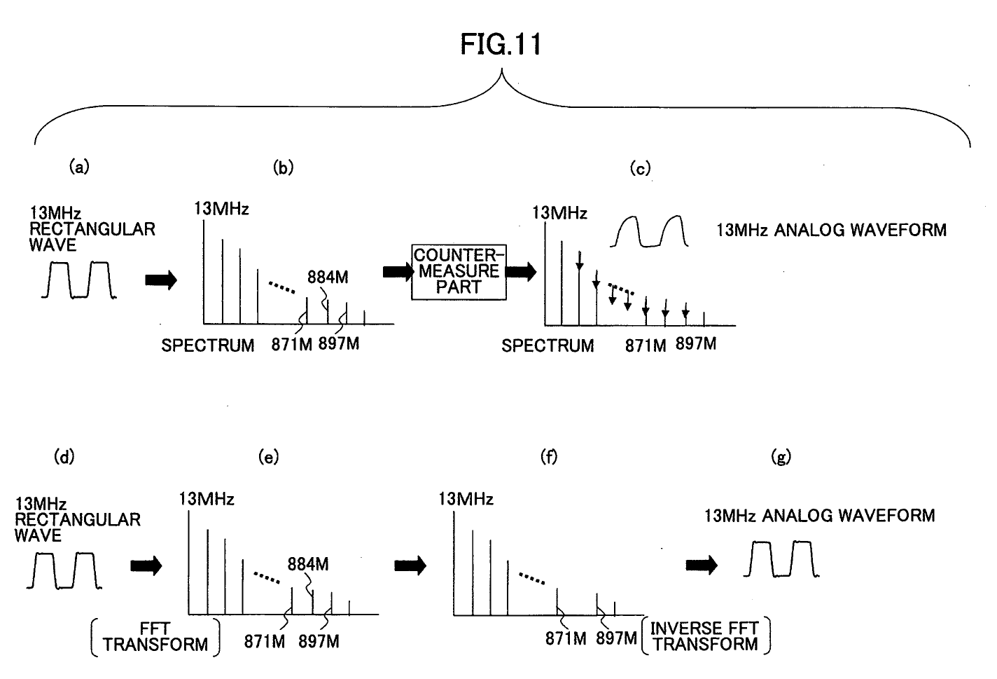

FIG. 11 illustrates a method of generating the transmission clock signal in the clock oscillation circuit 110-2 of the embodiment 3 (depicted in FIG. 11, (d), (e), (f), (g)) in comparison to the related art (depicted in FIG. 11, (a), (b), (c)).

FIG. 11, (b), (e) depict a spectrum of the use clock signal which is a rectangular wave signal of 13 MHz depicted in FIG. 11, (a), (d). As depicted in FIG. 11, (b), (e), the spectrum includes a series of respective harmonic components, i.e., 871 MHz (67-th), 884 MHz (68-th), and 897 MHz (69-th). It is noted that these harmonic components are depicted in FIG. 11, (b), (e) as 817M, 884M and 897M, respectively. In these harmonic components, the harmonic component of 884 MHz falls within the reception frequency band 875 through 885 MHz, and thus, may cause reception interference.

In the above-mentioned related art, a countermeasure part such as a filter is used. As a result, harmonic components are attenuated for a wide frequency range, as depicted in FIG. 11, (c). In this method of the related art, because the harmonic components are thus attenuated for the wide frequency range, rising and falling edge parts of the original rectangular waveform may become blunt. Thus, a problem may occur.

In contrast thereto, in the embodiment 3, FFT (fast Fourier transform) is carried out on waveform data of the given use clock signal having the rectangular waveform of 13 MHz. As a result, spectrum data as depicted in FIG. 11, (e) is obtained. From the thus-obtained spectrum, as depicted in FIG. 11, (f), only a harmonic component of 884 MHz which falls within the reception frequency band 875 through 885 MHz and thus may cause reception interference is removed. Then, inverse fast Fourier transform is carried out on the thus-obtained spectrum data. As a result, as depicted in FIG. 11, (g), corresponding waveform data of time base is obtained. Then, a signal having the thus-obtained waveform of time base is generated, and, is used as the transmission clock signal.

In the embodiment 3, different from the related art, the transmission clock signal has the waveform from which only the harmonic component which may cause reception interference has been removed as mentioned above. The thus-obtained transmission clock signal has the waveform of time base, in which, rising and falling edges can be effectively prevented from becoming blunt because, different from the related art in which the harmonic components are removed for the wide range as mentioned above, only the harmonic component actually causing reception interference has been removed.

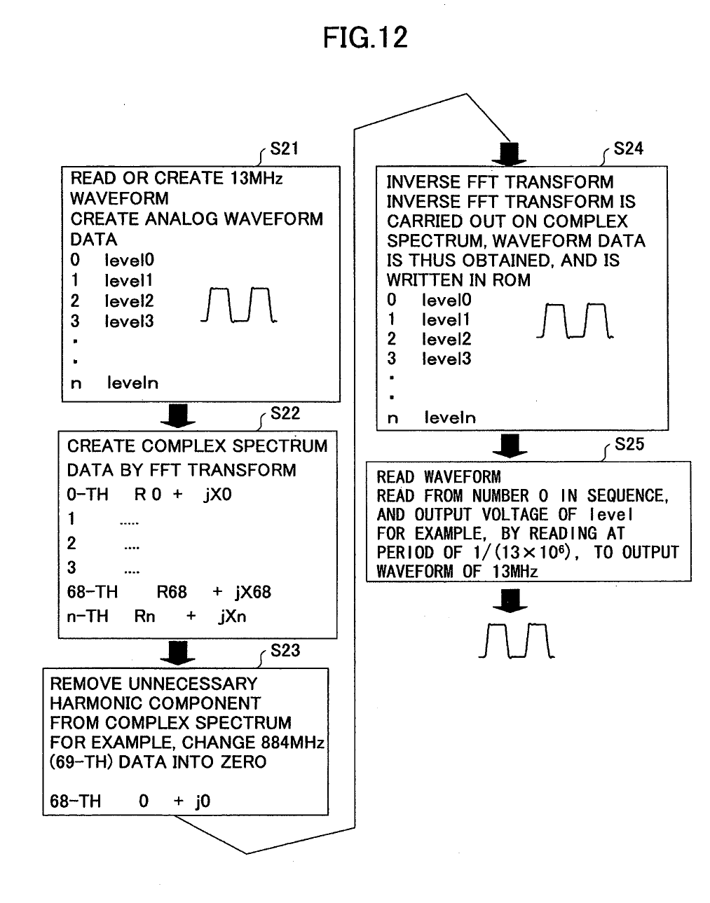

FIG. 12 depicts a flow of operation in the method of generating the transmission clock signal in the embodiment 3 described above with reference to FIG. 11, (d), (e), (f) and (g).

In step S21 of FIG. 12, waveform data of rectangular waves of 13 MHz which is the use clock signal is obtained.

In step S22, FFT transform operation is carried out on the thus-obtained waveform data. Thus, corresponding spectrum data is obtained.

In step S23, only spectrum data of a harmonic component falling within the reception frequency band 875 through 885 MHz which may cause reception interference, i.e., data of a harmonic component of 884 MHz in the above-mentioned example, is replaced by data of zero.

In step S24, inverse FFT operation is carried out on the thus-obtained spectrum data. Thus, corresponding waveform data of time base is obtained.

In step S25, based on the thus-obtained waveform data of time base, a signal having the same waveform is generated actually. As a result, a clock signal having a waveform from which only the harmonic component which may cause reception interference is removed is obtained. The thus-obtained clock signal is used as the transmission clock signal.

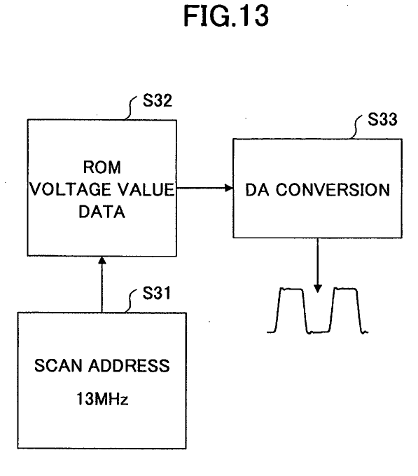

FIG. 13 is an operation flow chart illustrating an actual method of generating the transmission clock signal in the embodiment 3 carried out in step S25 of FIG. 12.

In FIG. 13, in step S31, an address scanning signal of 13 MHz is generated. Then, the thus-generated access scanning signal of 13 MHz is applied to a ROM, in which the waveform data of time base obtained in step S24 of FIG. 12 has been written. As a result, from the ROM, the waveform data of time base obtained in step S24 of FIG. 12 is read out in sequence in step S32.

Then, in step S33, digital to analog conversion operation is carried out on the thus-read-out waveform data of time base. Thereby, a clock signal of 13 MHz from which only the harmonic component which may cause reception interference is removed is obtained. The thus-obtained clock signal is used as the transmission clock signal.

What is claimed is:

1. A clock signal transmission method in a radio communication apparatus, comprising:
generating a second clock signal different from a first clock signal to be used by a clock signal using part of the radio communication apparatus, the first clock signal including a harmonic component which agrees with a reception frequency of the radio communication apparatus,
transmitting the generated second clock signal for the clock signal using part, and
generating the first clock signal from the transmitted second clock signal, and providing the generated first clock signal to the clock signal using part.

2. The clock signal transmission method as claimed in claim 1, wherein:
a frequency of the second clock signal is determined according to a frequency of the first clock signal.

3. The clock signal transmission method as claimed in claim 1, wherein:
a frequency of the second clock signal is an integer multiple of a frequency of the first clock signal, and neither the frequency of the second clock signal nor any harmonic component of the frequency of the second clock signal agrees with the reception frequency of the radio communication apparatus.

4. The clock signal transmission method as claimed in claim 1, wherein:
a frequency of the second clock signal is 1/integer of a frequency of the first clock signal.

5. The clock signal transmission method as claimed in claim 1, wherein:
Fourier transform is carried out on the first clock signal, a harmonic component which agrees with the reception frequency is determined from a thus-obtained spectrum, the determined harmonic component is removed from the spectrum to obtain a harmonic removed spectrum, inverse Fourier transform is carried out on the harmonic removed spectrum to obtain the waveform of the second clock signal.

6. The clock signal transmission method as claimed in claim 1, wherein:
the radio communication apparatus comprises an antenna part configured to receive a radio communication signal having the reception frequency,
the clock signal transmission method comprises a first generating step of generating the second clock signal different from the first clock signal, and a second generating step of generating the first clock signal from the transmitted second clock signal, and providing the generated first clock signal to the clock signal using part,
in the radio communication apparatus, the first generating step and the second generating step are carried out by a transmission clock signal oscillation circuit and a frequency conversion circuit, respectively, by a timing generation circuit and a use clock signal oscillation circuit, respectively or by a transmission clock signal oscillation circuit and a waveform shaping circuit, respectively, and a clock signal transmission wiring member is used for transmitting the second clock signal for the clock signal using part, and
the transmission clock signal oscillation circuit or the timing generation circuit is mounted on a first circuit substrate, the frequency conversion circuit, the use clock signal oscillation circuit or the waveform shaping circuit and the clock signal using part are mounted on a second circuit substrate, the antenna part is provided between the first circuit substrate and the second circuit substrate, the clock signal transmission wiring member is provided to pass on or in the vicinity of the antenna part between the first circuit substrate and the second circuit substrate.

7. A radio communication apparatus using a clock signal, comprising:
a transmission clock signal generation part configured to, when a harmonic component of a first clock signal used by a clock signal using part agrees with a reception frequency of the radio communication apparatus, generate a second clock signal different from the first clock signal;
a clock signal transmission part configured to transmit the second clock signal, generated by the transmission clock signal generation part, for the clock signal using par; and
a use clock signal generation part configured to generate the first clock signal from the second clock signal, transmitted by the clock signal transmission part, and provide the generated first clock signal to the clock signal using part.

8. The radio communication apparatus as claimed in claim 7, wherein:
a frequency of the second clock signal is determined according to a frequency of the first clock signal.

9. The radio communication apparatus as claimed in claim 7, wherein:
a frequency of the second clock signal is an integer multiple of a frequency of the first clock signal, and neither the frequency of the second clock signal nor any harmonic component of the frequency of the second clock signal agrees with the reception frequency of the radio communication apparatus.

10. The radio communication apparatus as claimed in claim 7, wherein:
a frequency of the second clock signal is 1/integer of a frequency of the first clock signal.

11. The radio communication apparatus as claimed in claim 7, wherein:
the transmission clock signal generation part carries out Fourier transform on the first clock signal to obtain a spectrum, determines from the spectrum a harmonic component which agrees with the reception frequency, removes the determined harmonic component from the spectrum to obtain a harmonic removed spectrum, carries out inverse Fourier transform on the harmonic removed spectrum to obtain a waveform of the second clock signal.

12. The radio communication apparatus as claimed in claim 7, comprising:
an antenna part configured to receive a radio communication signal having the reception frequency, wherein:
the transmission clock signal generation part and the use clock signal generation part comprises a transmission clock signal oscillation circuit and a frequency conversion circuit, respectively, a timing generation circuit and a use clock signal oscillation circuit, respectively or a transmission clock signal oscillation circuit and a waveform shaping circuit, respectively, and the clock signal transmission part comprises a clock signal transmission wiring member, and
the transmission clock signal oscillation circuit or the timing generation circuit is mounted on a first circuit substrate, the frequency conversion circuit, the use clock signal oscillation circuit or the waveform shaping circuit and the clock signal using part are mounted on a second circuit substrate, the antenna part is provided between the first circuit substrate and the second circuit substrate, the clock signal transmission wiring member is provided to pass on or in the vicinity of the antenna part between the first circuit substrate and the second circuit substrate.
